(19) United States
(12) Patent Application Publication
(10) Pub. No.: US 2016/0312478 A1
(43) Pub. Date: Oct. 27, 2016

(54) SUPPORT APPARATUS, SYSTEMS AND METHODS OF USING THE SAME

(71) Applicant: Randall Klapperich, McHenry, IL (US)

(72) Inventor: Randall Klapperich, McHenry, IL (US)

(21) Appl. No.: 15/135,711

(22) Filed: Apr. 22, 2016

Related U.S. Application Data
(60) Provisional application No. 62/150,923, filed on Apr. 22, 2015.

(51) Int. Cl. E04F 21/00; F16L 55/07; F16L 3/16; F16M 13/02

(52) U.S. Cl. CPC E04F 21/00; F16M 13/022; F16L 55/07; F16L 3/16

(57) ABSTRACT

A support apparatus is described. The support apparatus includes a bracket having an elongated support arm disposed onto and extending from a surface of the bracket. Alternatively, the support apparatus includes a bracket having an extending supporting horizontal surface. The support apparatus can be removably attached to upright, spaced structures, such as wall studs, and used as a supporting device or apparatus in the construction industry

The present invention claims priority to U.S. Prov. Pat. App. No. 62/150,923, titled “Support Apparatus”, filed Apr. 22, 2015, which is incorporated herein by reference in its entirety.

### TECHNICAL FIELD

The present invention relates to a support apparatus. More specifically, the present invention relates to a support apparatus including a bracket having an elongated support arm disposed onto and extending from a surface of the bracket. Alternatively, the support apparatus includes a bracket having an extending supporting horizontal surface. The support apparatus can be removably attached to upright, spaced structures, such as wall studs, and used as a supporting device or apparatus in the construction industry.

### BACKGROUND

Installing electrical wiring during initial construction or remodeling of buildings and other structures is commonplace. Wiring materials are usually provided in large reels or spools containing anywhere from 250 feet to 1000 feet of wire, depending on the type of wire being installed and its end use. Such large spools of wire can be cumbersome to handle and dispense from, particularly because the wire must be uncoiled from the spool during installation of the wiring into the walls of the structure. Placing the spool of wire on the floor, restricts rotation of the spool as the wire is being uncoiled, making the process tedious while potentially twisting the wire as it is removed from the spool. Additionally, the larger spools can be heavy to handle, while also taking up precious floor space, which is often limited during construction.

Furthermore, during construction, floor space is often limited as it is often occupied by building materials and tools. Thus, it would be advantageous to include a support apparatus having a horizontal surface for storing materials and tools, and for displaying paperwork and blueprints that may be needed during construction. The storage support apparatus would be elevated to a comfortable height, while keeping items off the floor and easily accessible to the builder.

A need, therefore, exists for improved support apparatus for use in the construction industry. Specifically, a need exists for providing an improved support apparatus for supporting a wire spool off the ground, and positionable at a level easily accessible to the user.

Moreover, a need exists for an improved support apparatus that can be easily and quickly attached to and removed from an existing building structure, including vertically extending wall studs.

Additionally, a need exists for an improved support apparatus that is easily engaged to an existing building structure without the need for additional fasteners.

Further, there is a need for an improved support apparatus that can be used as a horizontal storage surface for supporting materials off the ground.

In addition, a need exists for a support apparatus that is adjustable in orientation in relation to existing building structure, including vertically extending wall studs.

### SUMMARY OF THE INVENTION

The present invention relates to a support ideally for use in the construction/building industry for holding and supporting a variety of items.

To this end, in an embodiment of the present invention, a support apparatus is provided. The support apparatus comprises a U-shaped bracket comprising a first end, a second end, and a center section connecting the first end and the second end, the first end comprising a first U-shaped arm extending from the center section and the second end comprising a second U-shaped arm extending from the center section in the same direction as the first U-shaped arm; and an elongated support arm extending from the second U-shaped arm, wherein the elongated support arm extends at an upwardly inclined angle relative to a face of the second U-shaped arm.

In an embodiment, the support apparatus further comprises a gripping element disposed on a bottom surface of at least one of the first and second U-shaped arms extending from the center section.

In an embodiment, the support apparatus further comprises a first gripping element disposed on a bottom surface of the first U-shaped arm and a second gripping element disposed on a bottom surface of the second U-shaped arm.

In an embodiment, the elongated support arm is a rod.

In an embodiment, the support apparatus further comprising a stopper element disposed on a terminal end of the elongated support arm, the terminal end of the elongated support arm disposed opposite the end connected to the U-shaped bracket.

In an embodiment, the elongated support arm comprises a planar surface.

In an embodiment, the support apparatus further comprises an item requiring support disposed on the elongated support arm.

In an alternate embodiment of the present invention, a system for supporting one or more items is provided. The system comprises a support apparatus comprising a U-shaped bracket comprising a first end, a second end, and a center section connecting the first end and the second end, the first end comprising a first U-shaped arm extending from the center section and the second end comprising a second U-shaped arm extending from the center section in the same direction as the first U-shaped arm, and an elongated support arm extending from the second U-shaped arm, wherein the elongated support arm extends at an upwardly inclined angle relative to a face of the second U-shaped arm; and a wall stud disposed vertically, wherein the support apparatus is removably held to the wall stud via friction when the U-shaped bracket is disposed around three sides of the wall stud, wherein the elongated arm extends outwardly from the wall stud when the support apparatus is removably held to the wall stud.

In an embodiment, the support apparatus further comprises a gripping element disposed on a bottom surface of at least one of the first and second U-shaped arms extending from the center section, wherein the gripping element frictionally engages the wall stud when the support apparatus is removably held to the wall stud.

In an embodiment, the support apparatus further comprises a third U-shaped arm extending from a medial position of the center section, and a fourth U-shaped arm extending from the second end of the U-shaped bracket, the third and fourth U-shaped arms extending in an direction opposite the first and second U-shaped arm.

In an embodiment, the support apparatus further comprises a stopper element disposed on a terminal end of the elongated support arm, the terminal end of the elongated support arm disposed opposite the end connected to the U-shaped bracket.

In an embodiment, the elongated support arm comprises a planar surface, and further wherein the planar surface is disposed roughly horizontally when the support apparatus is removably held to the wall stud

In an embodiment, the support apparatus further comprises an item requiring support disposed on the elongated support arm.

In an embodiment, the system further comprises a second support apparatus comprising a second U-shaped bracket comprising a first end, a second end, and a center section connecting the first end and the second end, the first end comprising a first U-shaped arm extending from the center section and the second end comprising a second U-shaped arm extending from the center section in the same direction as the first U-shaped arm, and a second elongated support arm extending from the second U-shaped arm of the second support apparatus, wherein the second elongated support arm extends at an upwardly inclined angle relative to a face of the second U-shaped arm of the second support apparatus; a second wall stud disposed vertically, wherein the second support apparatus is removably held to the second wall stud via friction when the U-shaped bracket of the second support apparatus is disposed around three sides of the second wall stud, wherein the second elongated arm extends outwardly from the second wall stud when the second support apparatus is removably held to the second wall stud; and at least one item held atop both the first and second support apparatuses when the first and second support apparatuses are removably held to the first and second wall studs, respectively.

In an alternate embodiment of the present invention, a method for supporting one or more items is provided. The method comprises: providing a support apparatus comprising a U-shaped bracket comprising a first end, a second end, and a center section connecting the first end and the second end, the first end comprising a first U-shaped arm extending from the center section and the second end comprising a second U-shaped arm extending from the center section in the same direction as the first U-shaped arm, and an elongated support arm extending from the second U-shaped arm, wherein the elongated support arm extends at an upwardly inclined angle relative to a face of the second U-shaped arm; providing a wall stud disposed vertically; and placing the U-shaped bracket around three sides of the wall stud and angling the elongated arm downwardly to frictionally engage the first and second U-shaped arms with sides of the wall stud, wherein the elongated arm extends outwardly from the wall stud.

In an embodiment, the support apparatus further comprises a gripping element disposed on a bottom surface of at least one of the first and second U-shaped arms extending from the center section, wherein the gripping element frictionally engages the wall stud when the support apparatus is removably held to the wall stud.

In an embodiment, the support apparatus further comprises a stopper element disposed on a terminal end of the elongated support arm, the terminal end of the elongated support arm disposed opposite the end connected to the U-shaped bracket.

In an embodiment, the elongated support arm comprises a planar surface, and further wherein the planar surface is disposed roughly horizontally when the support apparatus is removably held to the wall stud.

In an embodiment, the method further comprises: disposing an item requiring support on the elongated arm.

In an embodiment, the method further comprises the steps of: providing a second support apparatus comprising a second U-shaped bracket comprising a first end, a second end, and a center section connecting the first end and the second end, the first end comprising a first U-shaped arm extending from the center section and the second end comprising a second U-shaped arm extending from the center section in the same direction as the first U-shaped arm, and a second elongated support arm extending from the second U-shaped arm of the second support apparatus, wherein the second elongated support arm extends at an upwardly inclined angle relative to a face of the second U-shaped arm of the second support apparatus; providing a second wall stud disposed vertically; placing the U-shaped bracket of the second support apparatus around three sides of the second wall stud and angling the elongated arm downwardly to frictionally engage the first and second U-shaped arms of the second support apparatus with sides of the second wall stud, wherein the second elongated arm extends outwardly from the second wall stud; and disposing at least one item atop both the first and second support apparatuses.

It is, therefore, an advantage and objective of the present disclosure to provide a support apparatus for use in the construction industry for supporting spools of wire and the like, while providing easy removal of wire from a spool.

It is another advantage and objective of the present disclosure to provide a support apparatus which is readily attached to and removable from an existing vertical structure such as a wall stud.

It is yet another advantage and objective of the present disclosure to provide a support apparatus that is one piece and easy to install and uninstall.

It is another advantage and objective of the present disclosure to provide a support apparatus which is readily attachable to an existing wall stud without requiring an additional fastener.

It is yet another advantage and objective of the present disclosure to provide a support apparatus which is adjustable in terms of angle and height when attached to the vertical structure.

It is yet another advantage and objective of the present disclosure to provide a support apparatus for securing spools of wire above the floor.

It is yet a further advantage and objective of the present disclosure to provide a storage support apparatus offering a horizontal storage surface for building materials, tools and the like above the floor.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a support apparatus of the present disclosure;

FIG. 2 illustrates a support apparatus prior to attachment to a vertical wall stud;

FIG. 3 illustrates a support apparatus of the present disclosure in a secured position to the wall stud;

FIG. 4 illustrates a support apparatus of the present disclosure in use;

FIG. 5 illustrates multiple support apparatus of the present disclosure forming a temporary shelf;

FIG. 6 illustrates another embodiment of the support apparatus of the present disclosure; and,

FIG. 7 illustrates yet another embodiment of the support apparatus of the present disclosure.

### DETAILED DESCRIPTION

The present invention relates to a support apparatus or structure for use in the construction industry. The present support apparatus can be used to support, for example, spools of electrical wire for easy uncoiling, or act as a supporting structure for a variety of items, including lumber, conduit and tools. In another embodiment, the present support apparatus can be used as a horizontal storage surface.

Forming the interior of a building typically involves constructing stud walls using a plurality of lumber studs. The studs are vertically extending from floor to ceiling, and spaced a predetermined distance from one another. Wall studs are typically 2×4 lumber, but can also be 2×6 lumber. Electrical wiring is threaded through openings in the studs, and is ultimately covered by plaster board or drywall connected to the studs. Electrical wiring is typically provided on spools, which can weigh between 60 to 90 pounds. Therefore, it is advantageous to provide a support apparatus that can support the heavy spools of electrical wiring, while permitting a user to easily unwind the wire from the spool for installation.

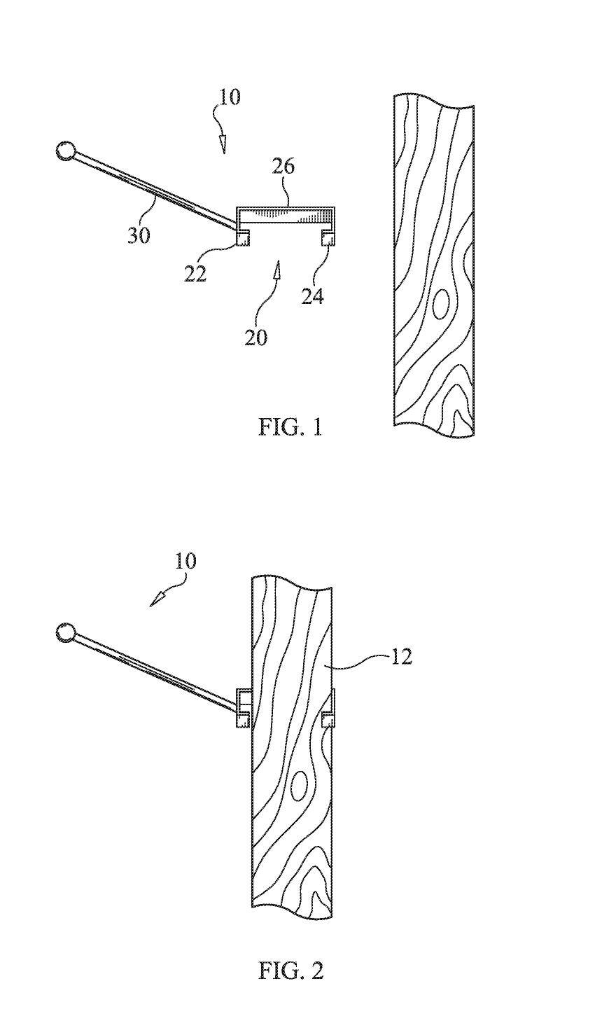

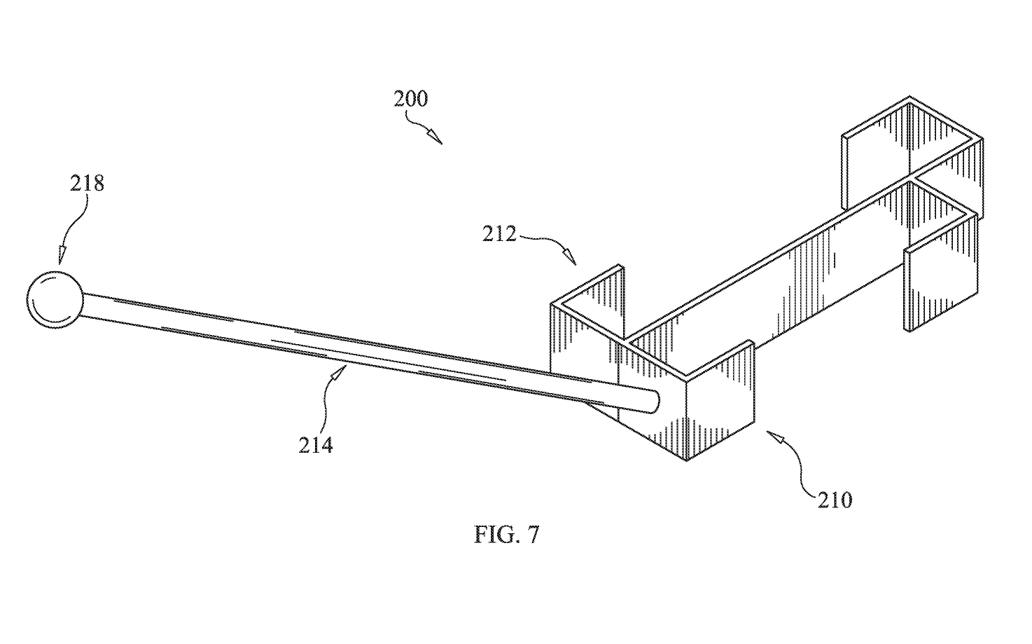

Now referring to the figures, wherein like numerals refer to like parts, FIGS. 1-5 illustrates an embodiment of a support apparatus 10 of the present disclosure. FIG. 6 illustrates another embodiment of the support apparatus 100 of the present disclosure. FIG. 7 illustrates yet another embodiment of the support apparatus 200 of the present disclosure.

Referring to FIG. 1, there is shown a first embodiment of the support apparatus 10. The support apparatus 10 includes an open or U-shaped bracket 20 and an elongated support arm 30 extending from an end surface of the bracket. The bracket 20 is formed from opposing U-shaped arms, forming a first end 22 and a second end 24 of the bracket. The ends 22, 24 are connected through a center section 26. The bracket 20, and specifically, the distance between the ends 22, 24 is designed to be slightly wider than the typical 2×4 wall stud 12 or a 2×6 wall stud, so that the bracket can engage with and be secured to the stud.

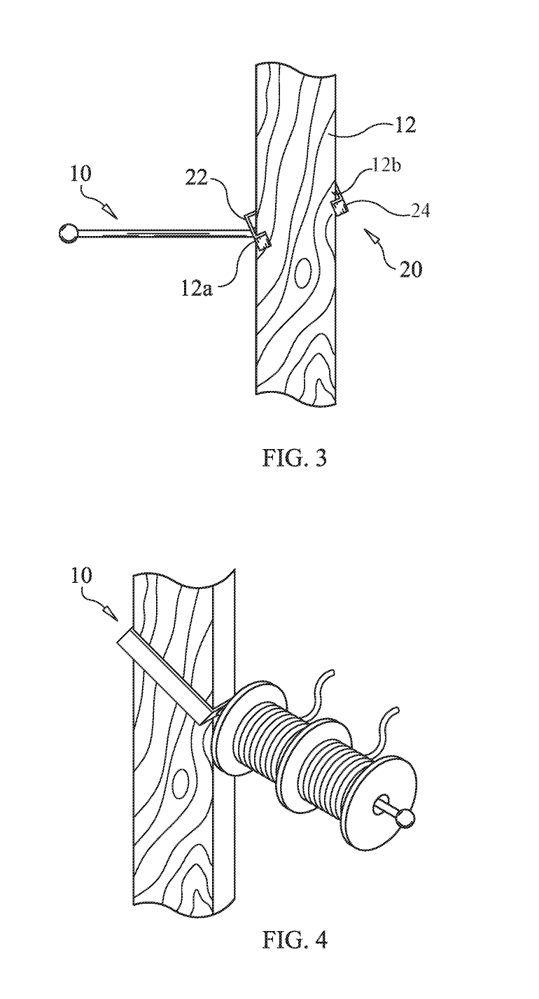

Extending from at least one of the ends 22, 24 of the bracket 20, is an elongated support arm 30. As shown in FIG. 2, the support arm 30 attaches to an end 22, 24 of the bracket 20 at about a 45° angle. At this angle, the user can line-up and engage the stud easily with the bracket 20. It should be noted that the support arm 30 may be disposed at any angle useful for the functions described herein.

To engage the support apparatus 10 to a wall stud 12, the user grasps the support arm 30 thereby positioning the apparatus in a first orientation, wherein the support apparatus 10 may approach the wall stud structure 12 perpendicularly as shown in FIG. 1. The bracket 20 subsequently surrounds the stud 12 as shown in FIG. 2. Specifically, the first end 22 and second end 24, and center section 26 of the bracket surround three sides of the stud 12. As shown in FIG, 3, the bracket 20 is then cantilevered into a second orientation when both the first end 22 and a second end 24 of the bracket are in contact with the wall stud 12 at a first location 12a and a second location 12b, respectively. The second end 24 may be positioned higher relative to the first end 22, as shown in FIG. 3.

The support apparatus 10 may be held in place in the second orientation by friction caused by the weight of the support apparatus pushing into and gripping the structure at the first and second locations. Any downward force on the support arm 30 increases the gripping force of the bracket to the supporting structure. For example, when a weighted item, such as a spool of wire is loaded onto the supporting arm 30, the additional weight increases the gripping force of the bracket 20. Optionally, the first end 22 and second end 24 of the bracket 20 may include gripping surfaces, such as ridges or grooves to ensure frictional contact with the surfaces of the stud 12. Alternatively, sharped edges or points may also form the gripping surface to further affix the bracket 20 to the wall stud 12 during use.

Preferably, when the support apparatus 10 is engaged to the supporting structure or stud 12, the elongated support arm 30 may be positioned horizontally or near-horizontal, with reference to the ground, in the second orientation. The support apparatus 10 may be moved and adjusted by first rotating the bracket 20 into the first orientation and adjusting the height as needed. The support apparatus 10 may be utilized on any number of structures, at varying heights, and easily adjusted accordingly.

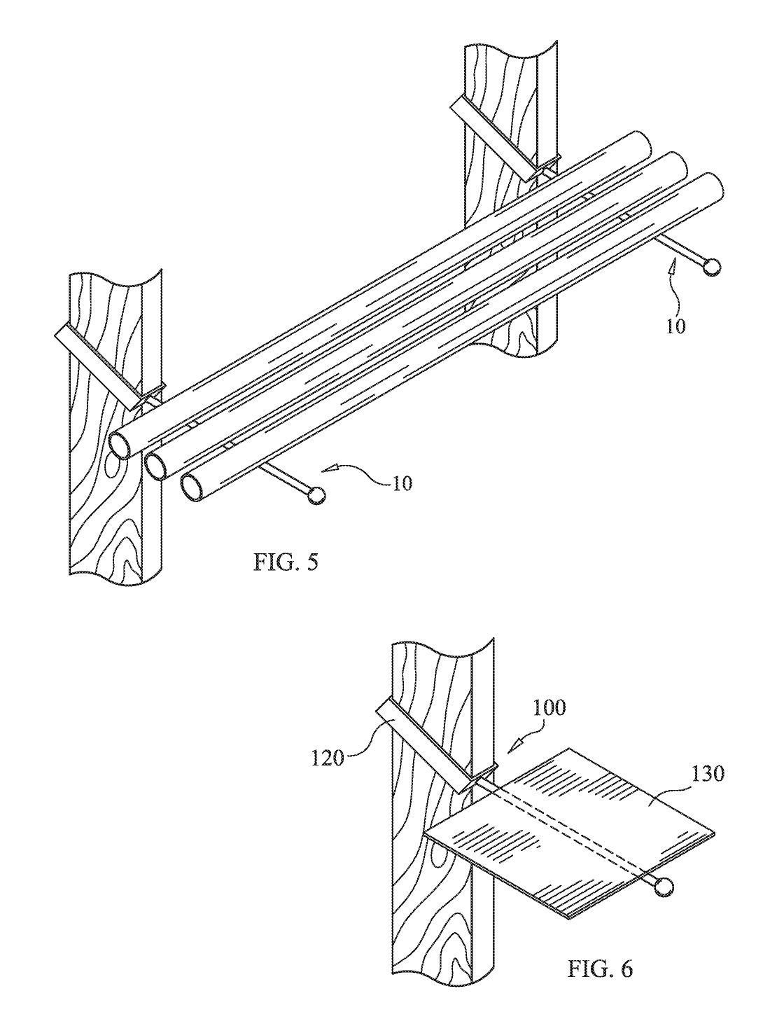

As shown in FIG. 4, when the support apparatus 10 is securely engaged with the stud 12 or other secure structure, the support arm 30 is configured to receive at least one spool of electrical wire or other wire. Mounting the spool of wire onto the support arm 30 permits the spool to rotate freely to dispense the wire, while avoiding twisting and kinking the wire. Additionally, the present support apparatus 10 is useful for elevating items above the floor, both for ease in handling and to save on limited floor space typical during construction.

FIG. 5 illustrates another use for the present support apparatus 10. Positioning at least two of the present support apparatuses in alignment creates a temporary shelf, ledge, counter or rack for holding lumber, conduit, piping, tools, or various other construction materials and items. The ease in attachment and removal provided by the support apparatus 10 results in a variety of options for creating supporting structures.

Referring to FIG. 6, there is shown another embodiment of a support apparatus 100. As with the first support apparatus 10 embodiment, this support apparatus 100 includes an open or U-shaped bracket 120. However, in place of the elongated support arm, there is an extending support surface 130 extending from a first end of the bracket. Although the support surface 130 is shown as a generally rectangular shape, it should be understood that the support surface can be any geometric shape.

To engage the support apparatus 100 to a wall stud 12, the user grasps the support surface 130 thereby positioning the apparatus in a first orientation, wherein the support apparatus 100 approaches the wall stud structure 12 perpendicularly as shown in FIG. 1. As previously described, the bracket 120 surrounds the stud 12 as shown in FIG. 6, and the support surface 130 is positioned horizontally and parallel to the floor. In this position, the support surface 130 acts as a receiving or storage surface for any number of items including, but not limited to, tools, building materials, paperwork and blueprints. The support surface 130 may further have a lip or ridge extending around a periphery thereof to prevent items from falling off the edges of the same.

FIG. 7 illustrated yet another embodiment of a support apparatus 200. In this embodiment, the support apparatus 200 includes two open or U-shaped brackets. Specifically, a first U-shaped bracket 210 is positioned back-to-back with a second U-shaped bracket 212. The brackets 210, 212 differ in length, specifically, the first bracket 210 is sized to engage a standard 2×4 stud, while the second bracket 212 is sized to engage a 2×6 stud. It should be understood that the brackets can a variety of sizes depending on the use of the support apparatus 200.

As with the previous support apparatus 10, the support apparatus 200 of FIG. 7 includes an elongated support arm 214 extending from an end of one of the brackets. Optionally, a second support arm may extend from an end of the second bracket. Another option may include a support surface as shown in the embodiment of the support apparatus 200 in FIG. 6.

Engaging the support apparatus 200 to a wall stud 12 is accomplished in the same manner as previously described with the first support apparatus 10 embodiment. The user grasps the support arm 214 thereby positioning the apparatus 200 in a first orientation, wherein the support apparatus approaches the wall stud structure (not shown) perpendicularly. One of either the first bracket 210 or the second bracket 212 subsequently surrounds the stud or other support structure. The selected bracket is cantilevered into a second orientation to frictionally engage with the wall stud.

A stopper 218 may be disposed on an end of the support arm 214, as illustrated in FIG. 7, to prevent items, such as spools or the like from sliding or falling off the end of the arm when in use. The stopper 218 may be welded, adhered, screwed or otherwise permanently or temporarily secured to the arm 214.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1. A support apparatus comprising:
a U-shaped bracket comprising a first end, a second end, and a center section connecting the first end and the second end, the first end comprising a first U-shaped arm extending from the center section and the second end comprising a second U-shaped arm extending from the center section in the same direction as the first U-shaped arm; and
an elongated support arm extending from the second U-shaped arm, wherein the elongated support arm extends at an upwardly inclined angle relative to a face of the second U-shaped arm.

2. The support apparatus of claim 1 further comprising:
a gripping element disposed on a bottom surface of at least one of the first and second U-shaped arms extending from the center section.

3. The support apparatus of claim 1 further comprising:
a third U-shaped arm extending from a medial position of the center section, and a fourth U-shaped arm extending from the second end of the U-shaped bracket, the third and fourth U-shaped arms extending in an direction opposite the first and second U-shaped arm.

4. The support apparatus of claim 1 wherein the elongated support arm is a rod.

5. The support apparatus of claim 1 further comprising:
a stopper element disposed on a terminal end of the elongated support arm, the terminal end of the elongated support arm disposed opposite the end connected to the U-shaped bracket.

6. The support apparatus of claim 1 wherein the elongated support arm comprises a planar surface.

7. The support apparatus of claim 1 further comprising:
an item requiring support disposed on the elongated support arm.

8. A system for supporting one or more items comprising:
a support apparatus comprising a U-shaped bracket comprising a first end, a second end, and a center section connecting the first end and the second end, the first end comprising a first U-shaped arm extending from the center section and the second end comprising a second U-shaped arm extending from the center section in the same direction as the first U-shaped arm, and an elongated support arm extending from the second U-shaped arm, wherein the elongated support arm extends at an upwardly inclined angle relative to a face of the second U-shaped arm; and
a wall stud disposed vertically, wherein the support apparatus is removably held to the wall stud via friction when the U-shaped bracket is disposed around three sides of the wall stud, wherein the elongated arm extends outwardly from the wall stud when the support apparatus is removably held to the wall stud.

9. The system of claim 8 wherein the support apparatus further comprises a gripping element disposed on a bottom surface of at least one of the first and second U-shaped arms extending from the center section, wherein the gripping element frictionally engages the wall stud when the support apparatus is removably held to the wall stud.

10. The system of claim 8 wherein the support apparatus further comprises a first gripping element disposed on a bottom surface of the first U-shaped arm and a second gripping element disposed on a bottom surface of the second U-shaped arm, wherein the first gripping element and the second gripping element frictionally engage the wall stud when the support apparatus is removably held to the wall stud.

11. The system of claim 8 wherein the support apparatus further comprises a stopper element disposed on a terminal end of the elongated support arm, the terminal end of the elongated support arm disposed opposite the end connected to the U-shaped bracket.

12. The system of claim 8 wherein the elongated support arm comprises a planar surface, and further wherein the planar surface is disposed roughly horizontally when the support apparatus is removably held to the wall stud

13. The system of claim 8 wherein the support apparatus further comprises an item requiring support disposed on the elongated support arm.

14. The system of claim 8 further comprising:
a second support apparatus comprising a second U-shaped bracket comprising a first end, a second end, and a center section connecting the first end and the second end, the first end comprising a first U-shaped arm extending from the center section and the second end comprising a second U-shaped arm extending from the center section in the same direction as the first U-shaped arm, and a second elongated support arm extending from the second U-shaped arm of the second support apparatus, wherein the second elongated support arm extends at an upwardly inclined angle relative to a face of the second U-shaped arm of the second support apparatus;
a second wall stud disposed vertically, wherein the second support apparatus is removably held to the second wall stud via friction when the U-shaped bracket of the second support apparatus is disposed around three sides of the second wall stud, wherein the second elongated arm extends outwardly from the second wall stud when the second support apparatus is removably held to the second wall stud; and
at least one item held atop both the first and second support apparatuses when the first and second support apparatuses are removably held to the first and second wall studs, respectively.

15. A method for supporting one or more items comprising:
providing a support apparatus comprising a U-shaped bracket comprising a first end, a second end, and a center section connecting the first end and the second end, the first end comprising a first U-shaped arm extending from the center section and the second end comprising a second U-shaped arm extending from the center section in the same direction as the first U-shaped arm, and an elongated support arm extending from the second U-shaped arm, wherein the elongated support arm extends at an upwardly inclined angle relative to a face of the second U-shaped arm;
providing a wall stud disposed vertically; and
placing the U-shaped bracket around three sides of the wall stud and angling the elongated arm downwardly to frictionally engage the first and second U-shaped arms with sides of the wall stud, wherein the elongated arm extends outwardly from the wall stud.

16. The method of claim 15 wherein the support apparatus further comprises a gripping element disposed on a bottom surface of at least one of the first and second U-shaped arms extending from the center section, wherein the gripping element frictionally engages the wall stud when the support apparatus is removably held to the wall stud.

17. The method of claim 15 wherein the support apparatus further comprises a stopper element disposed on a terminal end of the elongated support arm, the terminal end of the elongated support arm disposed opposite the end connected to the U-shaped bracket.

18. The method of claim 15 wherein the elongated support arm comprises a planar surface, and further wherein the planar surface is disposed roughly horizontally when the support apparatus is removably held to the wall stud.

19. The method of claim 15 further comprising:
disposing an item requiring support on the elongated arm.

20. The method of claim 15 further comprising the steps of:
providing a second support apparatus comprising a second U-shaped bracket comprising a first end, a second end, and a center section connecting the first end and the second end, the first end comprising a first U-shaped arm extending from the center section and the second end comprising a second U-shaped arm extending from the center section in the same direction as the first U-shaped arm, and a second elongated support arm extending from the second U-shaped arm of the second support apparatus, wherein the second elongated support arm extends at an upwardly inclined angle relative to a face of the second U-shaped arm of the second support apparatus;
providing a second wall stud disposed vertically;
placing the U-shaped bracket of the second support apparatus around three sides of the second wall stud and angling the elongated arm downwardly to frictionally engage the first and second U-shaped arms of the second support apparatus with sides of the second wall stud, wherein the second elongated arm extends outwardly from the second wall stud; and
disposing at least one item atop both the first and second support apparatuses.
